(19) United States
(12) Patent Application Publication
(10) Pub. No.: US 2003/0046311 A1
(43) Pub. Date: Mar. 6, 2003

(54) Dynamic search engine and database

(76) Inventors: Ryan Baidya, San Jose, CA (US); Valery Miftakhov, San Jose, CA (US)

Correspondence Address: Richard C. Kim, Morrison & Foerster LLP, Suite 500, 3811 Valley Centre Drive, San Diego, CA, 92130-2332, US

(21) Appl. No.: 10/177,346

(22) Filed: Jun. 19, 2002

Related U.S. Application Data
(60) Provisional application No. 60/299,708, filed on Jun. 19, 2001.

(51) Int. Cl. G06F 12/00

(52) U.S. Cl. 707/200

(57) ABSTRACT

An industry database and method of creating same is provided. The database is created in accordance with a process that includes: identifying a plurality of web sites meeting at least one search criteria; automatically extracting URL addresses for each of the plurality of web sites; automatically categorizing each of the web sites and their corresponding URL addresses in accordance with a predefined category structure; and automatically indexing and storing each of the URL addresses in accordance with the predefined category structure in the database. A method of using a database system is also provided. The method includes: storing in a database, information extracted from a plurality of web sites, wherein the information is automatically categorized and indexed in accordance with a predefined category structure and includes a plurality of URL addresses corresponding to the plurality of web sites; receiving a user query; executing a search engine in response to the user query that searches a subset of the stored information extracted from a subset of the plurality of web sites, and subsequently searching said subset of web sites to find additional information responsive to said user query.

### RELATED APPLICATIONS

This application claims the benefit of priority under 35 U.S.C. §119(e) to U.S. Provisional Patent Application Serial No. 60/299,708 entitled “Dynamic Search Engine and Database,” filed on Jun. 19, 2001, the entirety of which is incorporated by reference herein.

### BACKGROUND OF THE INVENTION

1. Field of the Invention

The invention relates generally to systems and methods for searching for and storing information and, more particularly, to a method and system for searching for specific company profile information and automatically updating portions of the information in an information database to provide dynamic real-time searching capability in a focused manner.

2. Description of Related Art

A conventional computer system 10 that may be used to search for information is generally illustrated in FIG. 1. The system 10 includes a computer network, e.g., Internet 12, that allows multiple client computers 14a-n to communicate with a vendor company server computer 16 in accordance with TCP/IP communications protocols. The server 16 is coupled to a database 18 and controls access to the database 18 by client computers 14a-n (collectively and individually referred to as “client computer 14” below).

The Internet 12 is a global network of interconnected computers and computer networks. The interconnected computers and networks exchange information using various services, such as electronic email, Gopher and the world wide web (“www”). The www service allows the server computer 16 to send graphical “web pages” of information to client computers 14. Each resource (e.g., a computer or web page) connected to the Internet 12 is uniquely identifiable by a Uniform Resource Locator (“URL”) address. To view a specific web page, the client computer 14 specifies the URL for that web page in a request, e.g., a hypertext transfer protocol (“http”) request, which is forwarded to the server 16 that supports the web page. The server 16 responds to the request by sending the requested web page (e.g., a home page of a web site) to the client computer 14.

The client computer 14 may be connected to the Internet 12 by various means known in the art, such as dial-up modem connection to an Internet Service Provider (ISP) or a direct connection to a network that is connected to the Internet 12. Typically, the client computer 14 is a personal computer in a home or a business environment which accesses the Internet 12 through a commercially available browser software package (e.g., Microsoft's Internet Explorer™ browser). The web pages themselves are typically defined by hypertext markup language (“HTML”) code that provides a standard set of tags that specify how a web page is to be displayed. When a client desires to view a particular web page, the browser software sends a request to the server 16 to transfer to the client computer 14 an HTML document that defines the web page. When the requested HTML document is received by the client computer 14, the browser displays the web page as defined by the HTML document. The HTML document typically contains various tags that control the displaying of text, graphics, user interface controls, and other functionality such as implementing queries or selecting items for purchase, for example. Additionally, the HTML document may contain URLs of other web pages available on the server 16 or other servers connected to the Internet 12.

Conventional computer systems 10, as described above, allow remote users located in different geographic locations to access and search for information contained in databases. Typically, such a database stores information in a relational format that supports a set of operations defined by relational algebra and generally includes tables composed of columns and rows for the data contained in the database. Each table may have a primary key, being any column or set of columns containing values which uniquely identify the rows in the table. The tables of a relational database may also include a foreign key, which is a column or set of columns the values of which match the primary key values of another table. A relational database is also generally subject to a set of operations (select, join, divide, insert, update, delete, create, etc.) which form the basis of the relational algebra governing relations within the database.

Using the system 10 described above, a client can search for information in a database, that stores information in a relational format, as follows. In response to a http request received by a client computer 14, the server computer 16 will provide at least one HTML web page to the client computer 14. At the client computer 14, the HTML web page provides a user interface that is employed by the user to formulate his or her requests for access to database 18. That request is converted by web application software within the server to a structured query language (SQL) statement. This SQL query is then used by database management software executed by the server 16 to access the relevant data in database 18. The server 16 then generates a new HTML web page that contains the requested database information.

Structured Query Language (SQL) is well known in the art and according to ANSI (American National Standards Institute), is the standard language for relational database management systems. SQL statements are used to perform tasks such as update data on a database, or retrieve data from a database. Some common relational database management systems that use SQL are: Oracle, Sybase, Microsoft SQL Server, Access, Ingres, etc. Although most database systems use SQL, most of them also have their own additional proprietary extensions that are usually only used on their system. However, the standard SQL commands such as “Select”, “Insert”, “Update”, “Delete”, “Create”, and “Drop” can be used to accomplish most functions. Client/server environments, database servers, relational databases and networks that utilize SQL are well known and documented in the technical, trade, and patent literature. For a discussion of database servers, relational databases and client/server environments generally, and SQL servers particularly, see, e.g., Nath, A., The Guide to SQL Server, 2nd ed., Addison-Wesley Publishing Co., 1995, which is incorporated by reference herein in its entirety.

Even with the research capabilities provided by the Internet, in many industries, such as the biotechnology or life sciences industries, the global nature of the market and the vast number of companies involved in the industry makes it almost impossible for any one company to be fully aware of what other companies are doing, what products they are developing and the opportunities that might exist for collaboration, licensing, and other business relationships and deals among the various companies. Additionally, because of the enormous amount of activity and information involved, it is extremely difficult to keep up-to-date on all this information. Furthermore, it is difficult to efficiently sort and categorize this “sea of information” in a meaningful way so as to provide an efficient search and/or research tool for companies, individuals or other entities desiring to perform a comprehensive, yet focused, searches for information regarding various topics and issues pertaining to the industry.

Thus, there is a need in such industries for an efficient search tool and database for allowing comprehensive, yet focused, searches of relevant information that is up-to-date and current. There is a need for a method and system for automatically, or semi-automatically, categorizing and classifying large volumes of information and keeping the information up to date so that it is current and reliable. Furthermore, there is a need for a method and system capable of efficiently searching and retrieving the most current information available in response to user queries.

### SUMMARY OF THE INVENTION

The invention addresses the above and other needs by providing a method and system for gathering and storing large amounts of information in a database, automatically categorizing the information in a focused and meaningful way, automatically updating the information, and providing the ability to perform focused search queries and retrieve static as well as dynamic information (i.e., new information or information that has changed since it was last updated in the database) that is relevant to a particular query.

Although the invention is described herein in the context of the biotechnology and life sciences industries (collectively referred to herein as the “biotechnology” industry), it will be readily apparent to one of ordinary skill in the art that the invention is not limited to these fields, but, rather, may have applications in various industries and fields, such as, electronics, nuclear energy, computer, and other consumer and/or research fields, for example, in which huge amounts of information may be available.

In one preferred embodiment of the invention, a method and system includes an Internet web site which operates a proprietary business development information database and search engine(s) for the biotechnology and/or life sciences industry. In one preferred embodiment, this web site is referred to herein as the BioZak.com web site and provides a business information, intellectual property and technology exchange marketplace in the biotech and life sciences fields. The global nature of the market for this service makes the Internet a perfect transactional medium. By creating a truly collaborative and flexible environment for the exchange of ideas, the BioZak.com web site provides an efficient tool and resource for companies to effectively learn about other companies and connect companies with mutual goals and interests.

In one preferred embodiment, the BioZak.com web site allows access to an Industry InfoBase currently containing information pertaining to more than 18,000 companies in the field, which makes it the largest bio-business database in the world. Currently, more than 13,000 companies are profiled with detailed information on their products, business activities, management team, executive board and so on. This number is continuously growing as more information is automatically located, categorized and indexed in the InfoBase.

In another embodiment, the BioZak.com web site includes access to an Opportunity Engine that provides a dynamic depository of time-critical business information designed to efficiently help companies find their technology partners. As used herein, the term “opportunity” refers to a product, service or idea that a company, individual or research institution offers or looks for in connection with areas such as licensing, collaboration, manufacturing, marketing, finding and human resources, for example. For example, some opportunity categories include: Licensing In, Licensing Out, Collaboration, Merger, Financing and Special services (e.g., accounting, legal, etc.).

In a further embodiment, an InfoBase Search Engine Suite provides a collection of intelligent search engines, each based on advanced text retrieving and processing algorithms discussed in further detail below, that perform the function of automatically searching for, collecting and categorizing information to be stored and indexed in the InfoBase. This system leverages the categorical data from the Industry Infobase to provide users a structured view of the business information available on the Internet. In one embodiment, sophisticated search algorithms capable of focusing in on specific topics are also provided. Search results can be organized, for example, by the company size, type, location or any other desired category.

In one embodiment, four specific search engines are deployed using the above-described platform. In a preferred embodiment, these search engines are Internet robot crawler type search engines that search the Internet for potentially relevant information. Such robot crawler search engines are well known in the art. The four specific search engines are referred to herein as: (1) the Company Directory Engine; (2) the Opportunity Engine; (3) the BioField Engine; and (4) the BioNews Engine.

The Company Directory Engine searches for new companies that are relevant to a particular industry or subsector of the industry (e.g., biotechnology) and stores new company names, URL addresses and other pertinent information into the InfoBase. New company names and their corresponding web site URLs are automatically identified, categorized, indexed and stored in a “Company Directory” table of the InfoBase. In one embodiment, URLs of web pages identified as “News” pages are also categorized, indexed and stored in a table that is relationally linked to corresponding company names and web site URLs stored in the Company Directory table. Additionally, company profile information pertaining to newly indexed companies (e.g., management team, contact information, products and services, size, age, etc.) are also automatically extracted from their corresponding web sites and indexed and stored in one or more tables, which are relationally linked to the Company Directory table, in the InfoBase. Additionally, as explained in further detail below, company profile information previously stored in the InfoBase is automatically updated on a periodic basis. The operation and functionality of the Company Directory Engine is discussed in further detail below.

The Opportunity Engine is a search engine that searches for potential opportunities in the industry. In one preferred embodiment, this search engine searches predetermined web site pages that are indexed by their corresponding URLs and stored in an appropriate table in the InfoBase. These predetermined web site pages are selected because they typically contain information pertaining to opportunities such as technology transfers, licensing requests or proposals, joint development proposals, etc. In a preferred embodiment, these web pages include particular pages identified in University web sites, government research web sites and/or non-profit research sites. The Opportunity Engine also identifies potential opportunities between members of the BioZak.com web site by monitoring and matching opportunity queries or requests submitted by members that are potentially related to one another. The operation and functionality of the Opportunity Engine is discussed in further detail below.

The BioField Engine is specifically designed to bring highly relevant information about activity in the field of biotechnology. In a preferred embodiment, the BioField Engine uses categorized and indexed URLs of web sites previously stored in the InfoBase to conduct focused searches for information that may be contained in the selected web sites corresponding to the URLs. Since, the information is mined directly from a first-hand source—web sites of relevant organizations—it is never obsolete. Additionally, since information is automatically mined and categorized, valuable human resources that would otherwise be spent on content development, are preserved. In one embodiment, this information is updated monthly. The operation and functionality of the BioField Engine is discussed in further detail below.

The BioNews Engine is a search engine that provides a specialized News index covering news in the industry. In a preferred embodiment, the BioNews Engine uses categorized and indexed URLs of News pages previously stored in the InfoBase to conduct focused searches for news that may be contained in the selected News pages corresponding to the URLs. Again, by using intelligent search software the invention is able to automatically process large amounts of data that previously required substantial human resources. In a preferred embodiment, News information is updated daily by the BioNews Engine. The operation and functionality of the BioNews Engine is discussed in further detail below.

In a further embodiment, through the Biozak web site, the following exemplary services are provided.

1. Public Services:

Limited access to the Industry InfoBase, containing names, contact information and profiles of the majority of biotech companies in the United States and throughout the world. Extensive search capabilities are built into the system.

Posting and editing of company profile and contact information to the Industry InfoBase.

Demo access to the Opportunity Engine—without access to contact information pertaining to specific opportunities.

Limited access to the unique BioField and BioNews search engines.

Industry news service that may be customized to each registered user.

Opt-in newsletters customizable for each user.

Public discussion forums allowing users freely to exchange information and ideas.

2. Membership Services:

Full access to the InfoBase and the BioField and BioNews search engines.

Full access to Opportunity search engine including posting and editing of the collaborative opportunities currently offered by the client company.

Tracking the responses and providing visitation statistics.

Searching for and responding to the offers made by the other companies.

Access to a BioZak.com premium match-making service.

### BRIEF DESCRIPTION OF THE DRAWINGS

FIG. 1 illustrates a block diagram of a prior art computer network that may be utilized in accordance with the present invention.

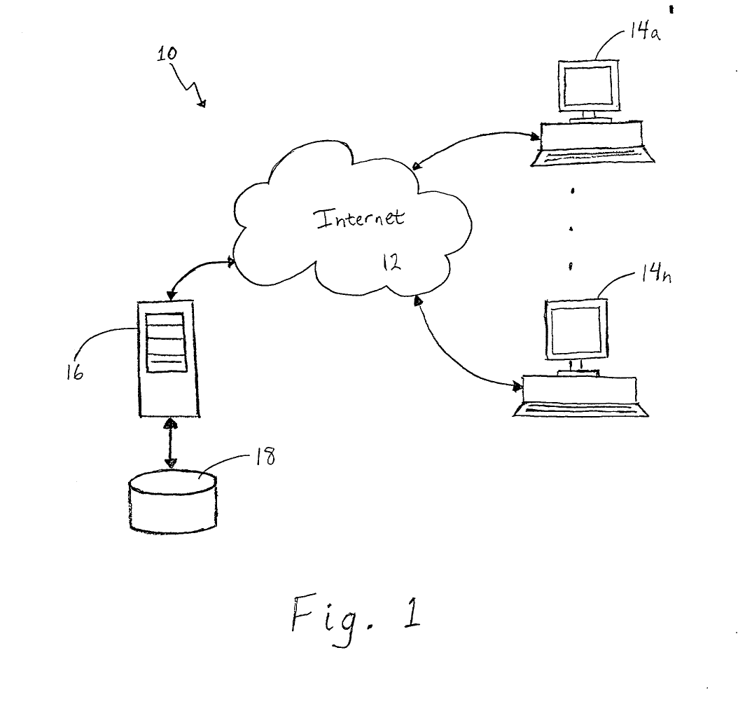

FIG. 2 illustrates web page that is presented to a user that accesses the BioZak.com web site, in accordance with one embodiment of the present invention.

### DETAILED DESCRIPTION OF THE PREFERRED EMBODIMENTS

The invention is described in detail below. Although the invention is described herein in the context of the biotechnology industry, it is readily apparent to those of ordinary skill in the art that the invention may be advantageously utilized in the context of other industries. In a preferred embodiment of the invention, a system includes a front-end user interface as well as a back-end processing engine.

Front-End User Interface

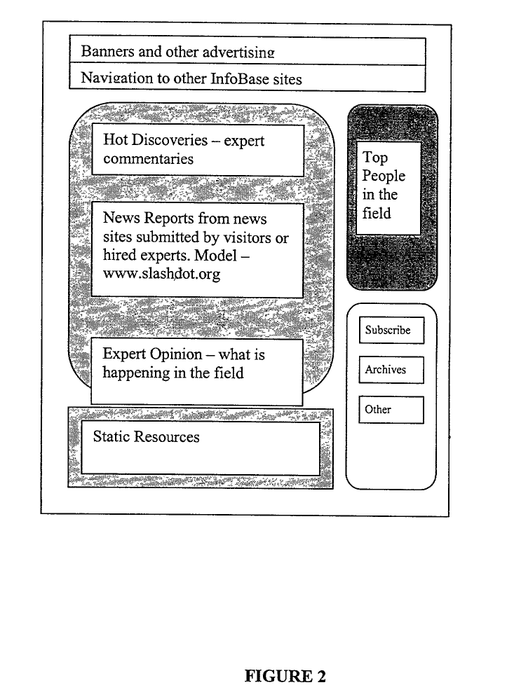

In one embodiment, the front-end user interface includes a BioZak.com home page that provides various user interface functions (e.g., search queries, requests, help line, etc.) and links to other web pages that may be of interest to the user. FIG. 2 illustrates an exemplary home page that may be presented to the user upon accessing and logging in to the BioZak.com web site. As shown in FIG. 2, the home page includes various windows or icons that serve as links to other web pages or system resources. As would be apparent to those of ordinary skill in the art, these other web pages can contain more specific information, and/or further links, and/or user input fields where users may enter input pertaining to queries to be executed or information to be stored by the system. In a preferred embodiment, a different user interface web page is presented to the user for various types of queries described herein (e.g., a BioField Query, a BioNews query or an Opportunity query).

In one embodiment, a BioField front-end user interface allows users to enter queries or search criteria to retrieve information collected by the BioField Engine. Similarly, the BioNews and Opportunity user interfaces allow user to enter or specify queries and/or search criteria (e.g., key words) to retrieve information collected by the BioNews and Opportunity Engines, respectively. Additionally, the Opportunity user interface allows members to submit requests or proposals to be matched by other members of the BioZak.com web site, thereby providing a point of contact for members to connect with one another. Techniques and methods of providing such computer-based, graphic user interface (GUI) web pages are well known in the art and extensively documented in the relevant literature.

Thus, the BioZak.com web site functions as an information portal and point of contact for companies and, in a preferred embodiment, business activities can be conducted or at least initiated through the web site. As would be apparent to those of ordinary skill in the art, the invention may be utilized in various industries, in addition to the biotechnology and life sciences industries, and an easy to use interface can be tailored to each customer group or industry.

In a further embodiment, BioZak.com home page provides a link to an administration page that allows users to register as a customer or member of the BioZak.com web site. The user is requested to provide registration information required by the vendor company that owns, operates and maintains the BioZak.com web site (e.g., BioZak, Inc. located at San Jose, Calif., U.S.A.). For example, the user may be requested to enter his or her home address and phone number, business address and phone number and financial information such as credit card account information for automatic debiting purposes. Additionally, the administration page may request that the user enter a login name and password that is required by the user for future login purposes. Such administration pages and techniques for registering users for the purpose of providing online services are well known in the art.

In one embodiment, the site is divided into public and private member access areas. On the public portion of the site, visitors can perform tasks such as obtaining information about the web site vendor company and the services offered. The BioZak.com home page contains information pertaining to the BioZak Management Team, Investor Relations, Career Opportunities and Contact Information, and much more. Visitors can also obtain limited access to the BioZak Industry database (“InfoBase”), containing comprehensive company listings in the field. In one embodiment, providing “limited access” includes displaying only a very small subset (e.g., 20 entries) of the available information to the visitor in response to a non-member query and/or removing contact information from all postings shown to users in the public mode.

In a preferred embodiment, a password-protected membership area provides full access to all information stored in the Industry InfoBase and full access to BioField, BioNews and Opportunity user interface functionality. In one embodiment, the Opportunity user interface further allows members to access comprehensive information pertaining to current offers, requests or proposals submitted by other registered BioZak members. Additionally, all members can submit, edit, or remove their offers and browse offers from other members. In a preferred embodiment, full-text search functions are provided to the member so as to allow searches for various types of information that may be available from the InfoBase. Additionally, “power search” functions based on boolean search techniques using key word and category fields are provided to members.

Back-End Processing Engine

The Back-End Processing Engine includes an automatic data-mining unit that periodically gathers information made available on the Internet to update the BioZak InfoBase industry database. In a preferred embodiment, the data-mining unit includes an AutoUpdater module that periodically executes the Company Directory, the BioField, the BioNews and the Opportunity search engines mentioned above to update the InfoBase with new information and/or replace outdated information. As discussed in further detail below, these engines search for relevant information from various data sources and, thereafter, categorize and index the information for storage in the InfoBase.

The InfoBase AutoUpdater is the main updating agent for the InfoBase. After initial information acquisition, the AutoUpdater module runs in the background to incrementally increase the size of the BioZak database (InfoBase) by discovering new relevant resources. The AutoUpdater module performs two primary functions: (1) update of the existing entries in the BioZak databases; and (2) discovery of new organizations and/or resources which would be beneficial to BioZak members.

To update existing entries in the BioZak InfoBase, appropriate search engines periodically check multiple sources to detect changes that might imply a necessary change to information stored in Infobase (i.e., add new information or replace old information with new information). In one embodiment, upon discovery of such changes, an Alert Systems module will request human administrators to review the entry in question. Using this approach it is estimated that the human effort required to keep the database current is reduced by a factor of 10 or more. Moreover, the Alert System helps administrators to update the profile by supplying them with relevant information that triggered the request.

One data source monitored by the present invention is company web sites. In one embodiment, BioField information comprises content from web sites associated with URLs stored in the InfoBase. These URLs serve as indices for storing the BioField information that is retrieved from corresponding web sites by the BioField Engine, as explained in further detail below. In a preferred embodiment, BioField information is updated and maintained with a latency of less than 1 month. Similarly, BioNews information comprises content from News pages corresponding to and indexed by News page URLs stored in the InfoBase. As explained in further detail below, BioNews information is retrieved by the BioNews Engine from the corresponding News pages. In one embodiment the BioNews content is updated and maintained with a latency of less than 2 days. It is understood that these update cycles of information retrieved and indexed by the BioField and BioNews search engines are exemplary only. Other desired update cycles may be programmably implemented by those of ordinary skill in the art, without undue experimentation, in accordance with the present invention.

To update BioField information, URLs of web sites are placed on a checklist that is attended to by the BioField Engine (e.g., an automatic robot program). This search engine periodically compares newer versions of web pages with old ones accessed using the BioField indices (e.g., URL addresses). When a change measure (e.g., number of words and/or graphics changed) exceeds a preset limit, the corresponding entry and all relevant pages will be submitted to an administration review list. Techniques for obtaining a change measure between two documents are well known in the art. In one preferred embodiment, if the change measure exceeds a preset threshold value, the old content from the web page is automatically replaced by the new content, without human administrator review. However, if the change measure is below the threshold value but still exceeds the minimum preset limit, the entry and all relevant pages are submitted to the administrator for review. Additionally, in one embodiment, changes reflecting particular types of events (e.g., new hires, new products, etc.) may be monitored using key word search techniques so as to alert administrators of particular changes of interest. When such changes are detected, all relevant pages are submitted to the administrator for review.

Similarly, in one embodiment, company news pages are periodically scanned by the BioNews Engine for structure-changing messages, for example, like those describing merger or acquisition, strategic alliance etc. A set of keywords is defined for each such event and is matched periodically, (e.g., daily, once a week, etc.). Any other types of events may also be searched using appropriate key words. Any potentially relevant entries are extracted and corresponding news web pages and/or company names are submitted to an administrator review list for subsequent further investigation by administrative personnel who will then update company profile information stored in the InfoBase accordingly.

In another embodiment, conventional industry news sources (e.g., Biospace.com, VentureWire.com, newsyahoo.com, etc.) are scanned for company names present in the InfoBase database. The processing philosophy is similar to processing of company news pages discussed above.

In addition to the proactive auto-updating functionality described above, in a preferred embodiment, the method and system of the invention purges the database of stale entries. In one embodiment, InfoBase entries that have not been updated for six months or longer, are reported to a BioZak web-site administrator for review. Additionally, any Opportunity entry by a member that is not updated for three months or longer is first reported to the member-submitter and after the next three months of inactivity is automatically deleted.

Other data sources may also be periodically scanned in accordance with the present invention. For example, patent databases may be periodically scanned for company names contained in the Infobase to determine whether any new patents have been issued to any of these companies. Such patent databases, for example, may include the U.S. Patent and Trademark Office databases (www.uspto.gov) and European Patent Office databases (see, http://l2.espacenet.com/espacenet/search).

Additional databases that may be searched by the present invention include FDA databases. These databases can be periodically scanned for company names contained in the Infobase to determine if any new drug approvals or tests for these companies have occurred. The following exemplary web sites may provide access to such databases: www.fda.gov; www.fda.gov/cder/drug/default.htm; and www.ClinicalTrials.gov.

Other data sources may include USENET newsgroups having web sites or pages accessible via the Internet. In one embodiment, the method and system of the invention attempts to extract information (e.g., objectives, intention profiles, location, etc.) from job postings listed by many companies in such newsgroup sites. An exemplary web site is www.google.com and an exemplay query for conducting a targeted search is provided below:

Query: company+about ′@′ copyright (biotechnology OR pharmaceuticals OR pharmaceutical OR genomics)—directory—consulting

The second function of the AutoUpdater module is to discover new organizations/resources which would be beneficial to BioZak members. This activity is divided into 2 steps: (1) discovery of new biotechnology organizations; (2) classification of the newly-discovered information into a predefined category structure.

Discovery of New Organizations

To populate the BioZak Infobase, focused data harvesting and processing techniques are employed to continuously increase the information stored and categorized in the Infobase, and provide subcategories for further refinement. An exemplary Company Directory index, constituting a portion of a predefined category structure, is provided in Appendix A, attached hereto. One preferred method of populating the database with information and classifying the information is described below.

In one preferred embodiment, in order to discover new organizations, targeted searches are periodically conducted using leading conventional search engines (e.g., google.com) using conventional keyword search techniques. Next, returned URLs are stored in a text file or database that is indexed to receive such URLs. The URL's are “un-stemmed” to identify and extract unique sites (i.e., select the shortest path containing at least a domain name—or even just the domain name). This is necessary because many search result “hits” may be different web pages from the same web site. Therefore, it is necessary to “unstem” the web page URLs to obtain their corresponding web site URLs and, thereafter, delete duplicate web site URLs.

Next, the method and system of the invention discards web site URLs already in the InfoBase and downloads content of the web sites (maybe 5-10 pages from each site) corresponding to the remaining URLs to be processed by a Texis indexing software program. Texis software is well known in the art and manufactured by Thunderstone, Inc., Cleveland, Ohio.

Next, word counts for the content downloaded from the web sites are calculated and stored in a word list to establish a basis for categorization. The word list is then purged of undiscriminating entries by a human administrator. Next, BioZak.com administrative personnel looks at a subset (e.g., 100-1000) of the total number of remaining web sites corresponding to the URLs and classifies them by hand (e.g., biotech company or not), thus creating training/testing sets. Next, an artificial intelligence classifier program is executed using the training/testing sets as input to create a statistical model of those companies classified as biotech companies and a statistical model of non-biotech companies. Each statistical model includes statistical information pertaining to the words found in corresponding web sites. Such classifiers are well-known in the art. For example, a simple classifier from the WEKA package of support vector mechanism classifiers may be used on a whole data sample.

Examples of specific classifiers are WEKA from New Zealand Waikatu University or the SVM classifier from Cornell University. As known in the art, classifiers are software systems that separate input textual data into several categories. There are several general types of classifier implementations based on Neural networks, rule-based, support vector machines etc. Learning classifiers are those that can derive the aggregate properties of the documents in specific categories. Such classifiers are divided into supervised and non-supervised learning classifiers depending on whether they are presented with a preset category structure and accompanying training set.

After the statistical models are created, tested and validated using techniques known in the art, any remaining web sites from the original list of web sites, or web sites discovered from future searches, may be automatically classified as either belonging to this class or not (e.g., biotech company or not) by comparing the target web site content with the statistical models described above. As is known in the art, such comparisons rarely result in an exact match with any single previously classified web site, but rather result in a “confidence score” which indicates a measure of similarity with the statistical model. Confidence scores typically comprise two elements, precision and recall, which together may be used to calculate the confidence score. Various techniques and algorithms for determining precision and recall values and calculating a confidence score are known in the art and/or could easily be implemented by those of ordinary skill in the art, without undue experimentation, in accordance with the present invention. In one embodiment, if the confidence score for a target web site is above a threshold value (e.g., 90%), the web site is automatically classified and stored in the InfoBase without human administrator review. If the confidence score is in a range below the threshold value, the web site is presented for human administrator review for manual classification.

In a preferred embodiment, the invention uses a supervised learning SVM classifier called “svmlight.” Generally, the process of running such classifier programs includes the following steps:

1. A category tree structure is created manually by people knowledgeable in the field.

2. A limited number of a total sample of search result documents (e.g., content from web sites or web pages) are categorized into a category of the above category tree. This is the training/testing set for that category.

3. The classifier is run on the training/testing set to learn the properties of the class. This results in the creation of a statistical model that is used to make categorization decisions for the remaining documents in the total sample. Since we know what category each entry really belongs to (we categorized them manually in step 1), we can evaluate the performance of our classifier. There are 2 performance metrics—precision and recall. In one embodiment, precision indicates the percentage of correct decisions while recall indicates the percentage of categories correctly identified.

5. Obtained precision/recall values are compared to threshold values. If the result is satisfactory, the classifier is run on the remaining total sample of documents.

6. The above process is repeated for each category or subcategory in the category tree.

In further embodiments, various criteria, other than word content, may be used to create the statistical models. In one embodiment, the “site structure” of web sites or pages are included as criterion in the decision process. For example, research companies usually have a smaller number of links in their web pages than directories, news sites etc. Additionally, the depth/width of research company web pages are smaller than those of directories, new sites, etc. As used herein, the term “depth” refers to the number of levels of web pages that may be accessed using html links to move from one level to another. The term “width” refers to the number links on any single web page. Thus, a web page that includes ten links to other web pages is said to have a width of ten pages.

After the classification process is completed, web sites and their corresponding URLs that are not classified as belonging to biotech companies are discarded. Company names from the remaining web sites are automatically extracted and then stored and indexed, along with its corresponding URL, in a table within the Infobase. A preferred process for automatically extracting company names from web sites is described in detail below. In a preferred embodiment, indexing of new information in the database is automatically performed by Texis software that is well-known in the art.

After company information has been stored and indexed as described above, searches may be executed to obtain further information about newly added companies. In one embodiment, the Company Directory Engine conducts further searches for information pertaining to, for example, a company's profile (e.g., products or services offered, location, age, management team, etc.) by accessing the web sites indexed by their URLs in the InfoBase.

Techniques and methods of extracting particular types of information from documents such as web pages are known in the art. Such techniques can include decision tree algorithms and comparison of the target content with previously generated statistical models representing a training set of documents in which the desired types of information have been found. Again, these techniques for automatically extracting information from a web site will typically produce a confidence score with each extraction. For example, an extraction may produce the name “John Doe” as the CEO of a target company with a confidence score or 90%. In other words, the extraction algorithm is 90% confident that John Doe is the name of the CEO. In a preferred embodiment, when the confidence score is above a threshold value, the invention automatically stores the information in an appropriate table, properly indexed and related back to the corresponding company profile information. If the confidence score is below the threshold value, the extracted information is presented for human administrator review. In one embodiment, this information extraction process is repeated once a week to populate the InfoBase with new information or update old information with new information.

In one embodiment, to continuously add new company information to the InfoBase, a customized modular data mining robot crawler, utilizing known data-mining and web crawling techniques, periodically crawls through a subsection of the Internet looking for BioTech company web sites. Upon each match, the method and system checks whether this company is already included in the Industry InfoBase and if the answer is negative, submits the company name and web site URL to the database for categorization and indexing, in accordance with the methods described above.

In one embodiment, company names are identified and extracted from a document or set of documents (e.g., a web site) in accordance with the following procedure. First, word phrases of 1-3, or more, words in length are identified and their frequencies counted for a current document or set of documents associated with one web site. Additionally, word phrase frequencies are counted for the total sample of documents (e.g., all “hits” identified as biotechnology company web sites). The phrase frequencies for the current document or set of documents is then compared with the phrase frequencies for the total sample of documents. The idea behind this comparison is that a company name should occur more often in the current document (set of documents) and far less often in the total sample of documents.

In performing the above phrase frequency counts and comparisons, results are improved when the phrase consists of the words occurring rarely in the total sample. Additionally, the location of the phrase may also be considered because, generally, company names appear at or near the beginning of a document. Therefore, the closer to the beginning of the document that a phrase is found, the more likely it is a company name. Accordingly, phrases found at the beginning of a document may be given more weight as phrases occuring later. Additionally, in one embodiment, phrases found in titles or which are associated with <h*> tags, such as html tags are also given more weight.

As would be readily apparent to those of ordinary skill in the art, various phrase frequency criteria and other criteria (e.g., locations of phrases, etc.) may be utilized in order to create a weighted algorithm for extracting company names from each unique web site. In one embodiment, to determine the exact parameters for such an algorithm, a decision tree system and method is used, wherein the decision tree method processes a predefined training set of correct names and random phrases which are not correct company names. In this way, a statistical model of correct company names may be created by calculating values associated with phrase frequencies and other criteria using the training set of documents. In a preferred embodiment, a WEKA classifier/training program, or similar program, may be used to create the model. By comparing a target web site with the statistical model, the invention automatically identifies and extracts company names from web site content. Again, as described above, a confidence score can be calculated for each extraction and those having a confidence score above a threshold value can be automatically processed without human intervention.

After new companies have been identified, it is desirable to classify or sub-classify these new companies according to a detailed category structure for biotechnology companies, for example. In one embodiment, a 4-tiered classification structure is utilized which may consist of more than 250 categories and subcategories covering all aspects of the life science industry, for example. Such an exemplary classification structure is provided in Appendix A attached hereto. To provide added value to users, the system should be able to categorize as many companies in its database as possible. With the volume of data present in the database it is impossible to do by human efforts alone. This is one obstacle that other companies face in achieving broad Industry coverage. Having relied on a limited number of people to do all the work to update their databases, prior companies could not cover any significant fraction of the field. The method and system of the present invention overcomes this limitation to create the first truly comprehensive biotechnology InfoBase.

In one embodiment, for each category or subcategory defined in the classification structure, the following procedures are implemented by algorithms used to automatically classify information stored in the InfoBase.

As a first step, take a random sample of several hundred or more previously classified companies (N). For each of these companies, retrieve corresponding web site content and compute the word frequencies found in the content to create a list of word frequencies.

Next, review the list and take out all the words that do not possess enough discriminating power. Also discard all words with frequencies below N/4.

### EXAMPLE

5926 products

| | |
|---|---|
| 5432 new | OUT |
| 5346 information | OUT |

5033 contact

| | |
|---|---|
| 5013 com | OUT |
| 4845 inc | OUT |

4795 research

| | |
|---|---|
| 4586 home | OUT |

4580 development

| | |
|---|---|
| 4429 search | OUT |

4127 product

| | |
|---|---|
| 3656 2000 | OUT |

In one embodiment, the resulting word count (feature vector dimension) is kept in a range of 500-1000 words. Additionally, some of the words may be permutations of each other, like “product” and “products.” Therefore, a REX expression (e.g., “product*”) may be created to cover all such permutations.

The above steps result in a list of discriminating words that can be used in a training routine. In one embodiment, a training feature vector is calculated using the following equation:

(A_{—}1, . . . , A_n)/sqrt(sum(A_i*A_i)),

where A_i is the frequency of the i-th word on the list within a current company's web site for i=1 to n. In one embodiment, frequency values may be normalized based on the size (e.g., total number of words) of the current company's web site. However, in some cases this normalization may be too crude in which case, the invention also uses an Inverse Document Frequency equation defined as follows:

IDF_i=log(N/DF_{—}i)

where N is the total number of documents, DF_i is the number of documents where the i-th word is present. These metrics were shown to improve the results of training algorithms substantially.

Next, select a training set of classified companies and calculate feature vectors for the set of classified companies. It is desirable to select cleanly classified companies (e.g., those exhibiting less class multiplicity) and to select a comparable number of companies belonging to each class. For example, select 100 companies classified as research companies (testing set) and 100 companies that are not classified as research companies (“garbage”). The set of 200 companies constitutes a “training set” for companies classified as “research” companies. Feature vectors for a classification are calculated as described above using the web sites of the companies belonging to the training set for that classification. In this way, a statistical model based on the calculated feature vectors is created that represents the companies belonging to a particular class. In a preferred embodiment, training is first performed at top-level classifications, thereafter, working down to finer subcategories.

Next, perform training on the set of training documents using a classifier from WEKA, for example. The method of the invention than tests the resulting statistically trained model on the testing set to evaluate overall performance on the testing set. Since the testing set consists of documents that have previously been classified as belonging to the particular class of interest, the results of this test should result in high confidence values. If the results on the testing set are encouraging, the statistically trained model is used to classify future documents (e.g., web sites, web pages, etc.).

In a preferred embodiment, if the automatic classification of new web sites into categories and/or subcategories results in a confidence score above a threshold value, the new web site is automatically indexed and stored in the InfoBase, using Texis software, without human administrator review. If the confidence score is below the threshold value, the web site is entered in a list for administration review.

BioField, BioNews and Opportunity Search Engines

The BioZak industry Infobase is updated with information retrieved by proprietary search engines referred to herein as the BioField, BioNews and Opportunity search engines.

The BioField search engine represents a new class of search engines targeted at business development professionals. Utilizing the contents of the proprietary industry InfoBase, an index of URL addresses of all companies in the field that have web sites listed in the Infobase is created. In one embodiment, the BioField search engine stores content taken directly from the web sites having URLs stored and indexed in the InfoBase in accordance with categories and subcategories created by the BioZak.com web site administrator. By giving members access to such a resource, the amount of time they have to spend finding organizations possessing interesting technologies and/or doing interesting research is greatly reduced. Compared to other commercial search engines like Google.com or Yahoo.com, the BioField search engines return less irrelevant results, saving time and, eventually, money for client companies.

The BioNews search engine offers clients access to news information from News pages that are indexed and compiled directly from third party web sites. In this way, the method and system of the invention is not dependent on human editors to define which news items are most important and therefore deny clients/users access to news stories from smaller companies. This is a significant improvement over the state of the art today as there may be value for business development professionals in that rejected information from small providers.

In a preferred embodiment, the method and system of the invention combine the proprietary industry InfoBase and Internet indices (e.g., URL addresses of web sites and/or web pages) compiled by automatic robot crawlers. The information contained in the InfoBase is used to segment, categorize and/or classify the indices by various criteria such as, for example, geographic location, company category, company size and company age. A plethora of other criteria may also be used. Internet robot crawlers capable of searching resources available on the Internet based on desired criteria are well-known in the art. Because such information is categorized and indexed in accordance with various classifications, users may conduct searches in much more focused manner and retrieve information that is truly relevant to their queries.

In one embodiment, a user query will not only result in a search of static information saved in the InfoBase regarding certain companies meeting specified criterion, but also trigger a dynamic search of relevant companies' web sites or web pages based on their corresponding URL addresses stored and indexed in the InfoBase. In this way, the method and system of the present invention retrieves the most up-to-date information related to the query. As a result, the system offers members the capability to conduct Internet searches restricted to certain regions of interest, further reducing the amount of irrelevant results one would otherwise get from less advanced search engine.

In a preferred embodiment, the data mining and web crawler software supports full-phrase searches as well as “Power” searches based on boolean search techniques using key words and/or classification fields. The BioField and BioNews search engines define industry domains from the InfoBase database for companies which have web sites defined by identifying and indexing web sites for a maximum number of companies in the biotechnology field. In one embodiment, the engines can be similar to search engines from publicly available software such as google.com.

The BioNews search engine provides the latest company news. In a preferred embodiment, a search is performed on domains (e.g., web sites) defined by keywords relevant for the news pages—“news”, “news story”, “news report” etc. In one embodiment, a human administrator purges the resulting list to make sure that it contains links only to head news pages. Alternatively or additionally, a human administrator can perform domain definition manually, determining news page URL addresses for each relevant company having a web site listed in the InfoBase.

The Opportunity Engine provides members with information pertaining to potential opportunities in the industry. In one embodiment, the Opportunity Engine searches pre-selected resources for relevant information. Such resources may include, for example, specific pages of university web sites, government research web sites, non-profit research company web sites, and other organizations' web sites that may be identified as containing information concerning technology transfers, licensing requests, etc., that are typically pertinent to opportunities in the industry. Some exemplary organizations having such web sites/pages are: University of Southampton, UCL Ventures, UUTECH Ltd., Imperial College Innovations Ltd., Actinova Limited, University of New York, Bioscience York, Science Park Raf SpA, West Pharmaceutical Services Ltd., APR Applied Pharma Research S.A., Brithealth Drug Technologies Ltd., Elan Corporation PLC, Ethypharm, etc.

In a preferred embodiment, information is retrieved and updated from these pre-selected web pages in accordance with the methods discussed above. Additionally, the retrieved information may be automatically classified, indexed and stored in the InfoBase in a similar fashion to the techniques discussed above.

In one embodiment, the Opportunity Engine searches indexed web pages having URLs and corresponding content stored in the InfoBase, when such web pages satisfy user criteria (e.g., all web pages associated with diagnostic companies). As described above, potentially relevant pages may be identified using key word and/or class field searches (e.g., “licens* and diagnostic”) entered by a member/user. Opportunity information/content stored in the InfoBase may be updated in a similar fashion to the techniques described above for updating BioField and BioNews information.

In a further embodiment, members are provided with a Technology Alert service that periodically monitors new information stored in the InfoBase and the activity on the members-only portion of the web site and sends out customized message-alerts when new information or other members' activity matches a pre-set pattern. For example, suppose that Company 1 wants to license a Drug Delivery Technology A and submits a request to the Technology Alert service. In response to this request, all currently available information stored in the InfoBase is searched and a customized message alert is sent to Company 1 if there is a perceived match. Some time later, however, if new relevant information is stored in the InfoBase as a result of automatic updates or newly discovered information sources, as discussed above, another customized message alert is transmitted to Company 1 if there is a perceived match.

Additionally, the Technology Alert module also compares member activities (e.g., submissions, searches, etc.) with one another to determine potential opportunity matches. For example, if sometime later, Company 2 performs a search on potential buyers of its newly developed ‘Drug Delivery’ technology. Usually, this would only result in Company 1 appearing as a search result for Company 2's query. With the Technology Alert service, however, the customized message-alert will also be sent to Company 1 informing it about a potential business opportunity. This gives Company 1 the option of reacting proactively to increase its chances for a successful match. Technology Alert requests can be submitted either independently of submissions into the opportunity database or at the time of submission. In the latter case, members will be prompted for ‘Alert Keywords’ that are used when scanning through other members' activities (e.g., requests, queries, submissions, etc.).

In addition to the Opportunity Engine discussed above, in one embodiment, a Start-Up Module that allows biotechnology start-up companies to submit their proposals and for investors/potential business partners (e.g., venture capital, pharmaceutical companies, research institutes, etc.) to review them is provided. Thus, through BioZak.com, companies and investors can access information pertaining to emerging technologies. In order to provide this service, management profiles, executive summaries, business plans and any other relevant documents from start-up companies are stored and indexed in the InfoBase. In one embodiment, a category/index system is developed and a specialized search engine is created and deployed to search for, extract and classify relevant information from documents submitted by or associated with start-up companies, in accordance with the techniques described above. In one embodiment, access to this information is given only to “qualified investment experts” to avoid the possibility of theft of any proprietary information. Additionally, a ‘finder’ fee for any successful deal (e.g., 3-10%) is charged to such investment experts.

In a further embodiment, a Jobs module is provided to allow members to post their job openings. One focus is on the executive job market in biotechnology industry because it is contemplated that many users of the BioZak.com web site will belong to this segment. This service provides additional value for the client. The Jobs module searches for, classifies, indexes and stores job opening/posting information from company web sites using the techniques described above. The Job module also receives resumes and other relevant documents from members who are seeking jobs and classifies and stores such documents in the InfoBase. Again, a category system is developed and deployed and a specialized search engine is created and deployed to search for, categorize, index and store extracted information. In a further embodiment, a ‘Job Alert’ subsystem is implemented to notify members/subscribers whenever a job opening submission matches a job seeker submission.

InfoBase Database Architecture

In one embodiment, source code used to create an InfoBase relational table structure is an Open Source program that can be downloaded from www.MySql.com, for example.

In a preferred embodiment, information entries stored in the InfoBase are “linked” to one another such that changes to one entry may automatically affect changes to one or more other linked entries, in accordance with a specified linking protocol. This “linking,” for example, may identify a subset of entries that are related to or affect a potential business opportunity or event. For example, if news information indicates a merger between company A and company B, this information may be stored and indexed under merger information for companies A and B. However, other entries would be affected by this new information such as: company size, company management team, company name, etc. Thus, in one embodiment, the method and system of the invention implements appropriate software logic to update all related entries in the InfoBase, as necessary, if one of the related entries is updated with new information.

In one embodiment, the BioZak InfoBase system uses its multiple data sources to update related entries through “business logic links.” One goal of the BioZak InfoBase is to provide business development professionals with dynamic information they need to make profitable business decisions. In one embodiment, several data types are identified as being “linked” according to business logic. Exemplary data types are: industry directory, market opportunities present within the industry, new developments/important changes in industry players and human capital supply/demand. Naturally, all these data types are related to one another. These relationships are exploited in an automatic or semi-automatic fashion for the first time by the BioZak InfoBase.

In one preferred embodiment, as part of the AutoUpdater execution, the system searches the primary sources used by the BioField, BioNews, and/or JobFinder engines to update Company Directory and Opportunity information stored in the Infobase. As described above, the BioField, BioNews and JobFinder Engines access the primary information sources—company websites—and therefore are the first to be aware of new information. In one embodiment, key word searching techniques are used to monitor for particular types of events (e.g., company structure-changing events).

In one embodiment, a search algorithm is used to identify pieces of information that can be applied to change the content of Company Directory & Opportunity information to keep them up-to-date and precise. The following exemplary information is extracted and used to update relevant entries in the InfoBase:

1. Management team changes detected by the BioField engine

2. Contact information changes detected by the BioField engine

3. New financing/M&A transactions detected by BioNews engine

4. New partners detected by the BioNews engine

5. Hints towards changing the company direction detected by the JobFinder engine.

The BioSearch Engine leverages the information stored in the InfoBase to more efficiently search the Internet and update information stored in the InfoBase that are related to one another. All information pertaining to web sites in the InfoBase is indexed, adding member_ID to each entry in html, using a Texis database software from ThunderStone, Inc. Categorical information is also added to each entry to enhance search capabilities. Such information may include: a location code, company category, size, company age, no. of patents, etc., that is added to the index database. A search may then be performed using a query format of the following form:

select Url, $$rank r

from html

where Title\Meta\Body likep $q

and Title like $tq

and Url matches $uq

and Depth [symbol] $dq

and branch_ID=($branch_ID . . . )

and location_ID=($location_ID . . . )

and company_stage=($company_age . . . )

The user is presented with a prompt at the front-end interface to enter data for queries like the above.

A search is then performed based on the user's query. In one embodiment, the search is a Meta Search that first searches the InfoBase using a Texis core engine. Next the Internet is searched based on information (e.g., web site domain names) retrieved from the InfoBase using the BioSearch engine. Finally, a broad Internet search using one of the public Meta Search engines (e.g., dogpile.com) is performed.

In a preferred embodiment, every search result from searching the InfoBase, or from searching the Internet using information from the InfoBase, contains a link or reference identifier to a corresponding entry in the InfoBase for a particular company. One search criterion, for example, may be location. In one embodiment, multiple location choices are allowed and a search is performed on ‘location_ID’ fields that are linked to corresponding entries in the InfoBase. In one embodiment, entries in those tables are assigned the finest possible location. A few examples of location_ID fields are provided below.

<option>North America

<option>--United States

<option>-----California

<option>-----New Jersey

<option>--Canada

<option>Europe

<option>--Germany

In one embodiment, to enable users to efficiently define their region the system provides a graphical selection system that includes a map with checkboxes and a tree expansion function for each country or region shown on the map. The system also provides a text query entry system.

Other criteria may include company category (e.g., research, diagnostic, etc.), company size, company age, and an IP coefficient.” An IP coefficient reflects the amount of relevant intellectual property that a company owns. Various sources are consulted to establish the basis for calculating this coefficient. In one embodiment, a BioZak IP Analyzer module is executed to access the patent information for each desired company. Each company is assigned an “IP coefficient” which is computed from several factors.

In a preferred embodiment, patent information for a company is retrieved from various patent databases (US, Europe, World patent office), which are consulted automatically using the company name. The number of patents, their titles, patent numbers, and dates of issue are extracted and stored in a table. In one embodiment, an IP coefficient is normalized per company size. In a further embodiment, the IP coefficient depends on the number of relevant patents, their status (in-progress or issued) and issue dates (older patents are less valuable). Whether a patent is “relevant” depends on the context and breadth of the query.

In one embodiment, if a user is presented with a web page as a search result, the system displays the corresponding company's IP coefficient calculated on the basis of patents relevant or related to his or her search query. This may be accomplished, for example, by running a search over patent titles, abstracts and/or text of the specification and then weighing each matched patent with its rank. Such searching and ranking methods are well known in the art and can be performed by Texis software, for example. In other cases (when there's no apparent context), a pre-computed context-free IP coefficient may be presented that simply reflects total number of issued patents, for example. As would be apparent to those of ordinary skill, various criteria and weighting strategies may be implemented to calculate the IP coefficient in accordance with the present invention.

In another embodiment, FDA applications and Clinical Trials information may be searched and provided based on a user query. In order to perform such searches, the following exemplary data sources may be searched: www.fda.gov and/or www.clinicaltrials.gov, for example.

In one preferred embodiment, the following technologies are implemented in the system of the invention:

1. An Apache Web Server engine for processing user requests for static HTML pages and dynamic content generated on the fly. The Apache Web Server is well-known in the art and, currently, perhaps the most used server on the Internet.

2. A MySQL relational database system for storing, managing and retrieving large volumes of data generated by the web site. The MySQL database engine has been heavily used on such high-volume web sites as www.slashdot.org (over 1 million hits per month) and many others. Further information can be found on the MySQL web site at www.MySQL.com.

3. Perl programming language for middle layer communication between web server and database server. As is known in the art, Perl provides a fast development cycle. Speed constraints introduced by interpretative languages such as Perl are largely alleviated by using web server modules specifically designed for this purpose and available on the market for a small or no fee (e.g., mod_perl server module available from Apache Foundation).

In a further embodiment, the invention can be implemented as an InfoBase CD application that may be utilized by users not having access to the Internet or world wide web (www). The method of the invention includes regular releases of a BioZak InfoBase CD containing data and instructions to provide functionality and service to customers when they have limited or no access to the internet The CD contains information from the Industry Infobase (although it may not be the most current) and allows users to search for information offline. As used herein, the terms “Internet,” “world wide web,” “web” and “www” are used synonymously and interchangeably. The invention provides a CD ROM disk containing data and computer executable instructions that may be read by a CD ROM drive of a computer. The data stored on the CD includes information collected by the search engines described herein (e.g., BioField and BioNews engines) that may be retrieved and displayed to the user based on user queries or criteria as described herein. The CD also contains computer executable instructions that may be downloaded from the CD so as to allow the computer processor (e.g., central processing unit or CPU) to process user queries, criteria, etc. and retrieve the desired data. Techniques for implementing CD applications for performing various software-based functions are well known in the art.

Various preferred embodiments of the invention have been described above. However, it is understood that these various embodiments are exemplary only and should not limit the scope of the invention. Various insubstantial modifications to the preferred embodiments would be readily apparent to and easily implemented by those of ordinary skill in the art, without undue experimentation. Such modifications are contemplated to be within the spirit and scope of the present invention as set forth in the claims below.

[image]

[image]

[image]

[image]

[image]

[image]

[image]

What is claimed is:

1. A method of creating an industry database, comprising:
conducting an Internet search for information meeting at least one search criteria;
creating a first list of URL addresses corresponding to web pages identified as a result of said Internet search;
unstemming said URL addresses in said first list to create a second list of URL addresses corresponding to unique web sites;
comparing said second list of URL addresses to URL addresses previously stored in said database;
deleting URL addresses from said second list that are duplicative of URL addresses previously stored in said database so as to create a third list of URL addresses;
automatically categorizing at least one URL address from said third list as belonging to a predefined category; and
automatically indexing and storing said at least one URL under said predefined category in said database.

2. The method of claim 1 wherein said step of automatically categorizing comprises:
selecting a subset of URL addresses from said third list so as to specify a training set for creating a statistical model;
downloading content from web sites corresponding to said subset of URL addresses;
creating a first word count list for each web site corresponding to said subset of URL addresses;
manually discarding at least one word determined to be a non-discriminating word from said first word count lists, thereby creating a second word count list for each of said web sites;
manually classifying each URL address from said subset as either belonging to said predefined category or not belonging to said predefined category based on said content from said web sites corresponding to the subset of URL addresses;
creating a statistical model representative of word count characteristics exhibited by web sites belonging to said predefined category and those web sites not belonging to said predefined category, based on said second word count lists;
validating said statistical model on said training set of web sites;
automatically downloading content from a web site corresponding to said at least one URL address from said third list; and
automatically comparing said content from said web site corresponding to said at least one URL address to said statistical model so as to automatically categorize said at least one URL as either belonging to or not belonging to said predefined category.

3. The method of claim 2 further comprising calculating a confidence score based on said step of automatically comparing said content to said statistical model, wherein if said confidence score is below a threshold value, said at least one URL is presented to a human administrator for review.

4. The method of claim 2 wherein said statistical model further represents site structure characteristics of said web sites corresponding to said subset of URL addresses.

5. The method of claim 1 further comprising automatically extracting at least one company name associated with said at least one URL and, thereafter, automatically indexing and storing said at least one company name under said predefined category in said database.

6. The method of claim 5 wherein said step of automatically extracting said at least one company name comprises:
identifying and counting word phrase frequencies from web site content associated with said at least one URL, thereby creating a first list of word phrase frequencies;
identifying and counting word phrase frequencies in content from a plurality of web sites associated with URL addresses in said second or third lists of URL addresses, thereby creating a second list of word phrase frequencies; and
comparing said first list of word phrase frequencies with said second list of word phrase frequencies to determine which phrase in said first list of word phrase frequencies most likely constitutes said at least one company name.

7. The method of claim 1 further comprising:
automatically extracting company profile information from a web site associated with said at least one URL; and
automatically indexing and storing said extracted company profile information in said database such that it is relationally associated with said at least one URL.

8. The method of claim 7 wherein said company profile information comprises information pertaining to one or more of the following: products; services; management team; location; size; and age.

9. The method of claim 7 further comprising:
downloading content of a web site associated with said at least one URL address;
indexing and storing said content in said database such that is relationally associated with said at least one URL address; and
automatically and periodically updating at least a portion of said content with new content obtained from said web site associated with said at least one URL address.

10. The method of claim 9 wherein said step of automatically and periodically updating comprises calculating a change measure value based on differences between said content stored in said database and said new content, wherein if said change measure value exceeds a predetermined threshold value, said new content is stored so as to replace said at least a portion of said content in said database.

11. The method of claim 1 further comprising:
identifying at least one web page from a web site associated with said at least one URL address, wherein the at least one web page contains news information about a company associated with said web site;
extracting a URL address for said at least one web page;
indexing and storing said news information and said web page URL address such that they are relationally associated with said at least one URL address in said database; and
automatically and periodically updating said news information by accessing said web page using said web page URL address and determining whether new content is available.

12. The method of claim 11 wherein said step of determining whether new content is available comprises calculating a change measure value based on differences between said news information stored in said database and updated news information in said web page, wherein if said change measure value exceeds a predetermined threshold value, said updated news information is stored so as to replace said news information previously stored in said database.

13. A method of creating an industry database, comprising:
identifying a plurality of web sites meeting at least one search criteria;
automatically extracting URL addresses for each of said plurality of web sites;
automatically categorizing each of said plurality of web sites and their corresponding URL addresses in accordance with a predefined category structure comprising a plurality of categories; and
automatically indexing and storing each of said URL addresses in accordance with said predefined category structure in said database.

14. The method of claim 13 wherein said step of automatically categorizing comprises:
automatically downloading content from each of said plurality of web sites; and
automatically comparing said content from each of said web sites to at least one statistical model representative of at least one category in said predefined category structure.

15. The method of claim 14 further comprising calculating a confidence score based on said step of automatically comparing said content to said at least one statistical model.

16. The method of claim 14 wherein said statistical model represents word count characteristics of web site content previously categorized as belonging to said at least one category.

17. The method of claim 13 further comprising:
automatically extracting a plurality of company names each associated with a respective one of said URL addresses; and
automatically indexing and storing said plurality of company names under said predefined category structure in said database.

18. The method of claim 17 wherein said step of automatically extracting said plurality of company names comprises:
identifying and counting word phrase frequencies from content in said plurality of web sites, thereby creating a first list of word phrase frequencies;
for each of said web sites, identifying and counting word phrase frequencies found in each web site, thereby creating a second list of word phrase frequencies; and
for each of said web sites, comparing said first list of word phrase frequencies with said second list of word phrase frequencies to determine which phrase in said second list of word phrase frequencies most likely constitutes a respective company name.

19. The method of claim 13 further comprising:
automatically extracting company profile information from said plurality of web sites; and
automatically indexing and storing said extracted company profile information in said database such that it is relationally associated with respective ones of said plurality of web sites.

20. The method of claim 19 wherein said company profile information comprises information pertaining to one or more of the following: products; services; management team; location; size; and age.

21. The method of claim 19 further comprising:
downloading content from said plurality of web sites;
indexing and storing said content in said database such that is relationally associated with respective ones of said plurality of web sites; and
automatically and periodically updating at least a portion of said content with new content obtained from respective ones of said plurality of web site.

22. The method of claim 21 wherein said step of automatically and periodically updating comprises, for each respective web site, calculating a change measure value based on differences between said portion of said content previously stored in said database and new content found in said respective web site, wherein if said change measure value exceeds a predetermined threshold value, said new content is stored so as to replace said portion of said content previously stored in said database.

23. The method of claim 13 further comprising:
identifying at least one web page for each of said plurality of web sites, wherein the at least one web page contains news information about a respective company associated with each of said plurality of web sites;
extracting a URL address for each of said at least one web pages;
for each of said plurality of web sites, indexing and storing said respective news information and said respective web page URL addresses such that they are relationally associated with a respective one said plurality of web sites; and
for each of said plurality of web sites, automatically and periodically updating said respective news information by accessing said respective at least one web page and determining whether new content is available.

24. The method of claim 23 wherein said step of determining whether new content is available comprises calculating a change measure value based on differences between said respective news information stored in said database and updated news information in said respective at least one web page, wherein if said change measure value exceeds a predetermined threshold value, said updated news information is stored so as to replace said respective news information previously stored in said database.

25. An industry database, created in accordance with a process comprising the steps of:
conducting an Internet search for information meeting at least one search criteria;
creating a first list of URL addresses corresponding to web pages identified as a result of said Internet search;
unstemming said URL addresses in said first list to create a second list of URL addresses corresponding to unique web sites;
comparing said second list of URL addresses to URL addresses previously stored in said database;
deleting URL addresses from said second list that are duplicative of URL addresses previously stored in said database so as to create a third list of URL addresses;
automatically categorizing at least one URL address from said third list as belonging to a predefined category; and
automatically indexing and storing said at least one URL under said predefined category in said database.

26. The database of claim 25 wherein said step of automatically categorizing comprises:
selecting a subset of URL addresses from said third list so as to specify a training set for creating a statistical model;
downloading content from web sites corresponding to said subset of URL addresses;
creating a first word count list for each web site corresponding to said subset of URL addresses;
manually discarding at least one word determined to be a non-discriminating word from each of said first word count lists, creating a second word count list for each of said web sites;
manually classifying each URL address from said subset as either belonging to said predefined category or not belonging to said predefined category based on said content from corresponding web sites;
creating a statistical model representative of word count characteristics exhibited by web sites belonging to said predefined category and those web sites not belonging to said predefined category, based on said second word count lists;
validating said statistical model on said training set of web sites;
automatically downloading content from a web site corresponding to said at least one URL address from said third list; and
automatically comparing said content from said web site corresponding to said at least one URL address from said third list to said statistical model so as to automatically categorize said at least one URL as either belonging to or not belonging to said predefined category.

27. The database of claim 26 wherein said process further comprises calculating a confidence score based on said step of automatically comparing said content to said statistical model, wherein if said confidence score is below a threshold value, said at least one URL is presented to a human administrator for review.

28. The database of claim 26 wherein said statistical model further represents site structure characteristics of said web sites corresponding to said subset of URL addresses.

29. The database of claim 25 wherein said process further comprises automatically extracting at least one company name associated with said at least one URL and, thereafter, automatically indexing and storing said at least one company name under said predefined category in said database.

30. The database of claim 29 wherein said step of automatically extracting said at least one company name comprises:
identifying and counting word phrase frequencies from web site content associated with said at least one URL, thereby creating a first list of word phrase frequencies;
identifying and counting word phrase frequencies in content from a plurality of web sites associated with URL addresses in said second or third lists of URL addresses, thereby creating a second list of word phrase frequencies; and
comparing said first list of word phrase frequencies with said second list of word phrase frequencies to determine which phrase in said first list of word phrase frequencies most likely constitutes said at least one company name.

31. The database of claim 25 wherein said process further comprises:
automatically extracting company profile information from a web site associated with said at least one URL; and
automatically indexing and storing said extracted company profile information in said database such that it is relationally associated with said at least one URL.

32. The database of claim 31 wherein said company profile information comprises information pertaining to one or more of the following: products; services; management team; location; size; and age.

33. The database of claim 31 wherein said process further comprises:
downloading content of a web site associated with said at least one URL address;
indexing and storing said content in said database such that it is relationally associated with said at least one URL address; and
automatically and periodically updating at least a portion of said content with new content obtained from said web site associated with said at least one URL address.

34. The database of claim 33 wherein said step of automatically and periodically updating comprises calculating a change measure value based on differences between said portion of said content stored in said database and said new content, wherein if said change measure value exceeds a predetermined threshold value, said new content is stored so as to replace said at least a portion of said content in said database.

35. The database of claim 25 wherein said process further comprises:
identifying at least one web page from a web site associated with said at least one URL address, wherein the at least one web page contains news information about a company associated with said web site;
extracting a URL address for said at least one web page;
indexing and storing said news information and said web page URL address such that they are relationally associated with said at least one URL address in said database; and
automatically and periodically updating said news information by accessing said web page using said web page URL address and determining whether new content is available.

36. The database of claim 35 wherein said step of determining whether new content is available comprises calculating a change measure value based on differences between said news information stored in said database and updated news information in said web page, wherein if said change measure value exceeds a predetermined threshold value, said updated news information is stored so as to replace said news information previously stored in said database.

37. An industry database created in accordance with a process comprising the steps of:
identifying a plurality of web sites meeting at least one search criteria;
automatically extracting URL addresses for each of said plurality of web sites;
automatically categorizing each of said plurality of web sites and their corresponding URL addresses in accordance with a predefined category structure comprising a plurality of categories; and
automatically indexing and storing each of said URL addresses in accordance with said predefined category structure in said database.

38. The database of claim 37 wherein said step of automatically categorizing comprises:
automatically downloading content from each of said plurality of web sites; and
automatically comparing said content from each of said web sites to at least one statistical model representative of at least one category in said predefined category structure.

39. The database of claim 38 wherein said process further comprises calculating a confidence score based on said step of automatically comparing said content to said at least one statistical model.

40. The database of claim 38 wherein said statistical model represents word count characteristics of web site content previously categorized as belonging to said at least one category.

41. The database of claim 37 wherein said process further comprises:
automatically extracting a plurality of company names each associated with a respective one of said URL addresses; and
automatically indexing and storing said plurality of company names under said predefined category structure in said database.

42. The database of claim 41 wherein said step of automatically extracting said plurality of company names comprises:
identifying and counting word phrase frequencies from content in said plurality of web sites, thereby creating a first list of word phrase frequencies;
for each of said web sites, identifying and counting word phrase frequencies from web site content associated with said respective URL address, thereby creating a second list of word phrase frequencies; and
for each of said web sites, comparing said first list of word phrase frequencies with said second list of word phrase frequencies to determine which phrase in said second list of word phrase frequencies most likely constitutes a respective company name.

43. The database of claim 37 wherein said process further comprises:
automatically extracting company profile information from said plurality of web sites; and
automatically indexing and storing said extracted company profile information in said database such that it is relationally associated with respective ones of said plurality of web sites.

44. The database of claim 43 wherein said company profile information comprises information pertaining to one or more of the following: products; services; management team; location; size; and age.

45. The database of claim 43 wherein said process further comprises:
downloading content from said plurality of web sites;
indexing and storing said content in said database such that is relationally associated with respective ones of said plurality of web sites; and
automatically and periodically updating at least a portion of said content with new content obtained from respective ones of said plurality of web site.

46. The database of claim 45 wherein said step of automatically and periodically updating comprises, for each respective web site, calculating a change measure value based on differences between associated content previously stored in said database and new content found on said respective web site, wherein if said change measure value exceeds a predetermined threshold value, said new content is stored so as to replace said at least a portion of said associated content previously stored in said database.

47. The database of claim 37 wherein said process further comprises:
identifying at least one web page within said plurality of web sites, wherein the at least one web page contains news information about a respective company associated with a respective web site;
extracting a URL address for said at least one web page;
indexing and storing said respective news information and said respective web page URL address such they are relationally associated with a respective one said plurality of web sites; and
automatically and periodically updating said respective news information by accessing said respective at least one web page and determining whether new content is available.

48. The database of claim 47 wherein said step of determining whether new content is available comprises calculating a change measure value based on differences between said respective news information stored in said database and updated news information in said respective at least one web page, wherein if said change measure value exceeds a predetermined threshold value, said updated news information is stored so as to replace said respective news information previously stored in said database.

49. A database system comprising:
a relational database containing a plurality of URL addresses for a plurality web sites indexed and stored in accordance with a predefined category structure; and
a company directory search engine for automatically retrieving new URL addresses for new web sites, automatically categorizing said new URL addresses and new web sites, and storing at least a subset of said new URL addresses in said relational database in accordance with said predefined category structure.

50. The database system of claim 49 further comprising a BioField search engine for automatically downloading content from said plurality of web sites, automatically categorizing said content and storing said content in said relational database in accordance with said predefined category structure.

51. The database system of claim 50 wherein said BioField search engine also automatically and periodically updates at least a portion of said content with new content obtained from at least one of said plurality of web sites.

52. The database system of claim 49 further comprising a BioNews search engine that automatically identifies web pages within said plurality of web sites and indexes and stores URL address for said web pages in said database, wherein said web pages contain news pertaining to respective companies associated with respective web sites, wherein the BioNews search engine automatically downloads news content from said identified web pages, stores said news content in said database in accordance with said predefined category structure, and periodically and automatically updates said news content with new information obtained from one or more of said identified web pages.

53. The database system of claim 49 further comprising an Opportunity search engine that automatically and periodically searches preselected web pages having URL addresses stored and indexed in said database in accordance with said predefined category structure, wherein said preselected web pages contain information pertaining to opportunities for companies belonging to an industry, and wherein said Opportunity search engine automatically downloads, categorizes, indexes and stores content from said web pages and periodically updates this content with new content obtained from said web pages.

54. The database system of claim 53 further comprising a technology alert module for receiving a plurality of user queries relating to business opportunities and periodically comparing said user queries with one another as well as opportunity information stored and indexed in said relational database to determine if there is a potential match between two or more user queries or between a user query and one or more entries of opportunity information stored and indexed in the database, wherein said technology alert module sends a message to appropriate users if a potential match is found.

55. The database system of claim 49 further comprising a job module for automatically and periodically identifying and extracting job opening information from said plurality of web sites, indexing and storing said information in said relational database, and comparing said information with requests received from users of said system to determine if there is a potential match between one of said requests and said job opening information from one or more of said plurality of web sites.

56. The database system of claim 49 further comprising a start-up module for receiving a plurality of proposals from member companies, wherein the start-up module automatically categorizes and indexes each of said plurality of proposal in accordance with said predefined category structure, thereby allowing focused searches to be performed by other member companies desiring to view only a subset of said plurality of proposals indexed under one or more desired categories in said predefined category structure.

57. The database system of claim 49 wherein:
said relational database further contains company profile information extracted from said plurality of web sites, wherein said company profile information is indexed and stored in said relational database in accordance with said predefined category structure;
wherein at least a subset of the entries for said company profile information stored in the relational database are “linked” to one another such that changes to one entry trigger changes to one or more other linked entries, in accordance with a specified linking logic; and
wherein if one of said company profile entries are updated with new information, said one or more other linked entries are automatically updated in accordance with said specified linking logic.

58. The database system of claim 57 wherein said linked company profile information includes the following information types: management team, contact information, new financing, M&A transactions, and new partners.

59. A method of providing information responsive to user queries, comprising:
storing in a database, information extracted from a plurality of web sites, wherein said information is automatically categorized and indexed in accordance with a predefined category structure and wherein said information includes a plurality of URL addresses corresponding to said plurality of web sites;
receiving a user query;
executing a search engine in response to said user query wherein said search engine searches a subset of said stored information extracted from a subset of said plurality of web sites, wherein said subset of information is selected based on corresponding category indices that match said use query; and
searching said subset of web sites to find additional information responsive to said user query.

60. A database system for providing information responsive to user queries, comprising:
a database for storing information extracted from a plurality of web sites, wherein said information is automatically categorized and indexed in accordance with a predefined category structure and wherein said information includes a plurality of URL addresses corresponding to said plurality of web sites;
a user interface module for receiving a user query; and
a server computer for executing said user interface module and a search engine in response to said user query, wherein said search engine searches a subset of a said stored information extracted from a subset of said plurality of web sites, wherein said subset of information is selected based on corresponding category indices matching said use query, and wherein said search engine subsequently searches said subset of web sites to find additional information responsive to said user query.
